(19) United States
(12) Patent Application Publication
(10) Pub. No.: US 2016/0198889 A1
(43) Pub. Date: Jul. 14, 2016

(54) CAPSULE MULTI-PIERCER WITH ASSEMBLY MEANS

(71) Applicant: NESTEC S.A., Vevey (CH)

(72) Inventors: Jean-Marc Flick, Pomy (CH); Jean-Luc Colantonio, Grangetters-Pres-Romont (CH)

(21) Appl. No.: 14/912,119

(22) PCT Filed: Aug. 13, 2014
(86) PCT No.: PCT/EP2014/067284

§ 371 Date: Feb. 15, 2016

(30) Foreign Application Priority Data
Aug. 13, 2013 (EP) 13180165.6

(51) Int. Cl. A47J 31/40; B26F 1/00; B65D 85/804

(52) U.S. Cl. CPC A47J 31/407; B65D 85/8043; B26F 1/00

(57) ABSTRACT

An extraction unit (1) has a piercing device (10) for piercing a capsule (20). The piercing device includes: a base (14) with peripheral sections, such as generally straight peripheral sections (14a, 14b, 14c1, 14c2); a plurality of blades (11a, 11b, 11c) that protrude from the base along a longitudinal direction (12a′, 12b′, 12c′), each blade extending laterally generally along one of the peripheral sections (14a, 14b, 14c1); and a plurality of assembly members (15a, 15b, 15c), each assembly member (15a, 15b, 15c) extending and protruding from one of the peripheral sections (14b,14c2). At least one assembly member (15a, 15c) of said assembly members (15a, 15b, 15c) is located at least in part generally in the longitudinal direction (12b′, 12c′) under a corresponding blade (11b, 11c).

### FIELD OF THE INVENTION

The present invention relates to a device for piercing the capsule in a capsule extraction unit, to a combination of such extraction unit and a capsule, to the method of piercing the capsule and to the use of a capsule for such piercing.

For the purpose of the present description, a “beverage” is meant to include any human-consumable liquid substance, such as tea, coffee, hot or cold chocolate, milk, soup, baby food, etc . . . . A “capsule” is meant to include any pre-portioned beverage ingredient, such as a flavouring ingredient, within an enclosing packaging of any material, in particular an airtight packaging, e.g. plastic, aluminium, recyclable and/or biodegradable packagings, and of any shape and structure, including soft pods or rigid cartridges containing the ingredient.

### TECHNICAL BACKGROUND

Certain beverage preparation machines use capsules containing ingredients to be extracted or to be dissolved and/or ingredients that are stored and dosed automatically in the machine or else are added at the time of preparation of the drink. Some beverage machines possess filling means that include a pump for liquid, usually water, which pumps the liquid from a source of water that is cold or indeed heated through heating means, e.g. a thermoblock or the like. Especially in the field of coffee preparation, machines have been widely developed in which a capsule containing beverage ingredients is inserted in a brewing device. The brewing device is tightly closed about the capsule, water is injected at the first face of the capsule, the beverage is produced in the closed volume of the capsule and a brewed beverage can be drained from a second face of the capsule and collected into a receptacle such as a cup or glass.

Brewing devices have been developed to facilitate insertion of a “fresh” capsule and removal of the capsule upon use.

WO 2005/004683 and WO 2007/135136 relate to such brewing devices. The devices comprise a frame, a fixed holding part for the capsule, a movable holding part which is mounted relative to the frame in a sliding relationship, one or two knuckle joint mechanisms that provide a mechanical system which enables to close in a steady and fluid-tight manner the holding parts about the capsule while also resisting to the counter-force acting while re-opening and generated by the internal brewing pressure, and a handle for directly levering the knuckle joint mechanism. Such a device forms a simple assembly enabling insertion of the capsule by vertical fall through a passage in the frame and removal of the used capsule in the same direction as the insertion direction. The handle may serve to cover and uncover the passage for the capsule. The movable parts of the brewing device are actuated manually via the handle. The manual force required to move the movable parts varies during closure and opening of the machine and depends on the dimensional tolerances of the capsules used and the positioning and nature of the capsules as well as the temperature of the brewing unit. WO 2009/043630 discloses a beverage preparation machine including a brewing unit having a front part with a passage for inserting a capsule into the brewing unit. The front part is arranged to telescope out of the machine's housing for uncovering the passage for inserting a capsule into the brewing unit and telescopes into the brewing unit for sliding the passage under the housing and thus covering the passage by the housing. From a different approach, the actuation of the movable part of the brewing device may be motorized. EP 1 767 129 relates to a motor-driven extraction module for a capsule-based beverage production device. In this case, the user does not have to provide any manual effort to open or close the brewing device. WO 2012/025258 and WO 2012/025259 disclose other motorized machine for preparing beverages from ingredient capsules.

When the capsule containing the material to be extracted, e.g. a beverage ingredient, is partly or entirely sealed, in particular water and optionally air tight, it may be necessary to open the sealed capsule part by means of an appropriate opener. The opening may be delayed, i.e. during the extraction process of the capsule in the extraction unit e.g. as disclosed in EP 0 512 470 or in EP 2 068 684, or it may be carried out in the unit before extraction of the cartridge e.g. as disclosed in WO 02/00073 or in WO 02/35977. Further opening arrangements are disclosed in US 3,260,190, U.S. Pat. No. 5,649,472, CH 605 293, EP 512 468 and EP 242 556.

An extraction unit may typically include one or more blades for forming an opening in a capsule before extraction of the capsule. When a blade is used which does not itself include a liquid circulation duct, i.e. a duct for guiding liquid into or out from the capsule, the liquid normally circulates, outside and along the blade, into or out from the capsule in a passage formed inbetween the blade the boundaries of the opening formed in the capsule by the blade in the capsule. The passage formed between the blade and these boundaries may be too small for allowing the desired flow of liquid into or out of the capsule. As a result, the flow along the capsule may be too small, or the capsule may be torn in an unwanted manner about the boundaries (in the case of a pressurized outflow of liquid from the capsule) or the capsule may be crushed (in the case of a pressurized inflow or attempted inflow of liquid into the capsule).

This problem has been addressed in WO02/00073. An extraction unit is disclosed which includes several capsule piercing blades that pierce a capsule for allowing a circulating of liquid through the capsule. The blades have transverse though-openings that extend into a cartridge during extraction to provide an increased space along the blade so as to facilitate introduction of liquid from outside into the cartridge.

The presence of such a large through-opening across the blade improves significantly the flow of liquid into or out of the capsule by extending the section of the through-passage of liquid inwards in the blade about the boundaries of the opened capsule at the level of the blade. Such a large through-opening however also weakens the mechanical strength of the blade. This may become an issues over time, especially when harder capsules are used that are not easily pierced by the blade. Such an added constraint on the blade during piercing may of course lead to an early failure of a blade with a through-opening.

Another approach to improve the flow of liquid into is disclosed in EP 2012192347.8 where rams are used to enlarge openings formed by cutting or piercing elements in the capsule.

One problem encountered with prior art piercing, in particular piercing of capsule prior to any pressure rise within the capsule, resides in an insufficient circulation of fluid into the capsule. As mentioned above, solutions have been provided to this problem, for instance as disclosed in WO02/00073 and in EP 2012192347.8. Such systems improve the incoming flow in a capsule.

However, there is still a need to improve the flow distribution in a capsule. It has been proposed to increase the number of piercing elements and corresponding openings that are formed in the capsule. However, the greater the number of piercing elements, the greater the pressure needed to form all the openings with the piercing device and the greater the risk of crushing the capsule instead of piercing it. This risk is even increased with the increasing trend of reducing packaging materials for economic and environmental reasons, which leads to a structural weakening of the capsules.

Moreover, increasing the number of blades of a piercing device reduces the possibility of providing protruding assembly members on the device or leads to an increase of the overall size of the piercing device to provide space for the assembly members and the additional blades. Furthermore, changing the piercing device's assembly arrangement or overall size goes against the retrofittability of such piercing devices in existing capsule extraction units.

On the other hand, it has been proposed to provide an internal capsule distribution channelling connected to a capsule inlet and spreading inside the capsule the fluid fed into the inlet. However, the latter solution involves additional internal capsule components, which add to the capsule manufacturing costs.

Therefore, there is still a need to provide a piercing device for a capsule extraction unit that addresses at least some of the abovementioned problems.

### SUMMARY OF THE INVENTION

One aspect of the invention relates to a capsule extraction unit having a piercing device for piercing a capsule. The cooperation between the capsule and the extraction unit may relate to the preparation of a beverage from the capsule that contains a beverage ingredient to be extracted, such as coffee, tea, chocolate, cacao, milk or soup. Hence, the extraction unit may typically be incorporated in a beverage machine.

Such beverage preparation typically includes the mixing of a plurality of beverage ingredients, e.g. water and milk powder, and/or the infusion of a beverage ingredient, such as an infusion of ground coffee or tea with water. For instance, a predetermined amount of beverage is formed and dispensed on user-request, which corresponds to a serving. The volume of such a serving may be in the range of 25 to 200 ml or up to 300 or 400 ml, e.g. the volume for filling a cup or mug, depending on the type of beverage. Formed and dispensed beverages may be selected from ristrettos, espressos, lungos, cappuccinos, café latte, americano coffees, teas, etc . . . . In particular, a coffee machine may be configured for dispensing espressos, e.g. an adjustable volume of 20 to 60 ml per serving, and/or for dispensing lungos, e.g. a volume in the range of 70 to 150 ml per serving.

The piercing device of the extraction unit of the invention comprises:
a base with peripheral sections, such as generally straight peripheral sections;
a plurality of blades that protrude from the base along a longitudinal direction, in particular a longitudinal direction that is generally parallel to a direction of piercing the capsule in such unit, each blade extending laterally generally along one of the peripheral sections; and
a plurality of assembly members, each assembly member extending and protruding from one of the peripheral sections.

For instance, the assembly member is a spring member, e.g. a clip member. Typically, the assembly member is arranged for anchoring and/or positioning the base in a capsule receiver.

According to the present invention, at least one of the assembly members is located at least in part generally in the longitudinal direction under a corresponding blade.

Thus, instead of alternating the blades and the assembly members around a peripheral part of a base of a piercing device, a blade and an assembly member may be combined on a same part of the base so that the location at which an assembly member extends from the base can also serve as a location from which a blade extends.

Optionally, the piercing device, in particular the base, has one or more additional assembly arrangements e.g. at least one assembly arrangement selected from an assembly hole or a notch.

Typically, the piercing extremities of the elements are arranged to pierce the capsule prior to circulating an extraction fluid into the capsule.

The piercing device may have a first-type blade that is associated with an assembly member and a second-type blade that is not associated with an assembly member. For instance, the second-type blade(s) has/have a foot with a second width generally equal to a first width of a foot of the first-type blade(s). The first and second type blades can be disposed in alternation about an axis of the piercing device, the axis being for example a central axis of the piercing device and/or an axis parallel to the piercing direction.

Hence, the number of blades may be increased in a given volume even when the piercing device requires protruding assembly member(s) and/or is made of a single bent plate. This is particularly advantageous for retrofitting piercing devices having an increased number of blades in existing designs of extraction units, in particular without narrowing or compromising on the shape of the piercing parts of the blades.

The piercing device, or at least its blades, may be made of metal, such as steel or iron, or of ceramic or possibly hard polymeric material. The capsule wall to be opened by the blades should be made of a material that does not excessively wear the piercing extremities, such as plastic or aluminium. The capsule may also be made of biodegradable material.

Hence, the piercing device can be fitted with a large number of blades forming either a corresponding number of inlet openings or a corresponding number of outlet openings.

The risk of crushing the capsule when the openings are formed by the blades can be minimized by arranging the piercing device so that the openings are formed at different moments in time by the corresponding blades during the piercing of capsule in the extraction unit.

At least one assembly member can be located between the corresponding blade and the base. The base may be generally planar or annular.

At least one assembly member and the corresponding blade may extend from the same peripheral section.

The corresponding blade may form an overhang under which in the longitudinal blade direction at least part of the assembly member is located.

The base can extend between at least one assembly member and the corresponding blade. For example, the base is generally annular.

At least one assembly member may extend from an assembly peripheral section of the base that is opposite a blade peripheral section. For example, such peripheral sections are generally parallel to one another.

At least one assembly member can extend from the peripheral section in a direction generally parallel to the longitudinal direction of the corresponding blade.

Typically, the base, the blades and the assembly members are made of a single plate-like structure. In this context, a plate-like structure is a structure having a thickness that is several times smaller than the width and the length of the structure. Such a structure extends along its length and its width but not significantly along its thickness. Typically, the length and the width are each at least 10, 30 or 100 greater than the thickness of the structure. The structure is normally non-planar but curved and/or angled; the structure may though incorporate one or more planar sections such as the base, a blade and/or a protruding assembly member. For example, the structure is made from a single plate that is bent and cut to form the base, the blades and the assembly members.

The entire piercing device or parts thereof (e.g. such a base) may be made of a thin plate, e.g. a sheet, of constant thickness, e.g. of less than 1 mm, typically a thickness in the range of 0.05 to 0.5 mm.

A plate forming the cutting edge of the blade and the assembly member(s) may have a constant thickness along the blade.

The portion of the plate forming the blade may have a thickness that is tapered along the blade to form a sharper cutting ramp.

For instance, the blade and the assembly member is/are bent at angles in the range of 75 to 105 deg, such as 85 to 95 deg, relative to the base.

Each blade may have a piercing extremity arranged to pierce the capsule in a piercing direction, such as a direction generally parallel to the longitudinal direction of the blade at the piercing extremity, the piercing extremities being arranged to form at corresponding locations in the capsule either a series of corresponding inlet openings or a series of corresponding outlet openings. A plurality of piercing extremities are generally arranged in a circle or in an oval arrangement on a plane and optionally evenly spaced apart. Each piercing extremity may have a piercing axis parallel to the piercing direction, the blades of the piercing device being in a generally cylindrical arrangement about a generally central axis of the piercing device and being optionally evenly spaced apart. The piercing extremities may be generally located on different virtual piercing planes that are generally perpendicular to the piercing direction. Each piercing plane can have a total number of piercing extremities of 1, 2, 3, 4, 5, 6, 7 or 8.

The piercing device may have: a first-type of blades that is juxtaposed to at least one assembly member and that extends therewith from a first-type peripheral section; and a second-type of blades that extends alone from a second-type peripheral section. The second-type peripheral section can have a second width generally equal to a first width of the first-type peripheral section. The first and second type blades may be positioned in alternation about an axis, such as a central axis and/or an axis parallel to the piercing direction, of the piercing device.

At least one blade can have: an edge that is generally parallel to the piercing direction and an inclined edge intercepting the parallel edge to form the piercing extremity; or two edges inclined to the piercing direction and intercepting each other to form the piercing extremity.

The cutting edges of a blade may generally form a v- or u-arrangement. An edge can be in the shape of a straight and/or curved cutting ramp.

The piercing extremities can be arranged generally in a circle or oval or like arrangement and optionally evenly spaced apart. Each piercing extremity may have a piercing axis parallel to the piercing direction, the blades of the piercing device being in a generally cylindrical arrangement about a generally central axis of the piercing device and being optionally evenly spaced apart.

Typically, the extraction unit comprises a first capsule receiver, such as a receiver connected to a fluid line for circulating a fluid into a capsule pierced by the piercing device, in or on which the piercing device is mounted. The first capsule receiver may have means for securing assembly members in the receiver, such as recesses and/or protrusions cooperating with the piercing device.

The securing means of the capsule receiver may be further configured to secure assembly members that extend over substantially an entire peripheral section of the base and that are not located under any blade in the longitudinal direction. The latter assembly members are typically assembly members of prior art piercing devices. Hence, the piercing device of the invention may be configured to be fitted in a receiver (originally) configured for receiving prior art piercing devices.

Typically, the extraction unit comprises a second capsule receiver that is movable relatively to the first capsule receiver, between an open position for inserting or removing a capsule into or from such extraction unit and a closed position for extracting the capsule in such unit. For instance, the second capsule receiver is arranged to hold the capsule against the piercing extremities when the first and second receivers are relatively moved into the closed position generally parallel to the piercing direction.

Optionally, the assembly member(s) and the blade are at an angle and the capsule receiver has a rib extending between the assembly member(s) and the blade into this angle, typically forming a notch in the piercing device.

The invention also relates to a combination of an extraction unit as described above and a capsule.

Another aspect of the invention relates to a method of piercing, in such a combination, the capsule. The method comprises urging the capsule relatively against the piercing device along the piercing direction.

Yet another aspect of the invention relates to a use of a capsule for: being pierced by the piercing device of the above extraction unit; providing the above combination; or being pierced by the above method.

For instance, the capsule comprises a generally cylindrical or frusto-conical or domical or frusto-domical container that has a bottom and a cover. For instance, the container has an axis of symmetry such as an axis of revolution. The capsule may have a face to be pierced by all the piercing extremities of the piercing device, the piercing face being formed by the bottom or the cover of the capsule. The container axis may be generally parallel to piercing direction when the capsule is pierced by the piercing device in the extraction unit.

The part of the capsule pierced by the piercing device can be made of metal such as aluminium, of plastic, and/or of biodegradable material.

### BRIEF DESCRIPTION OF THE DRAWINGS

The invention will now be described with reference to the schematic drawings, wherein:

FIG. 1 is a perspective view of a piercing device of an extraction unit according to the invention;

FIG. 2 is a side view of the piercing device illustrated in FIG. 1;

FIGS. 3a to 3d show a piercing sequence of a capsule in an extraction unit according to the invention, capsule receivers of the unit being illustrated in FIGS. 3a and 3d;

FIG. 4 schematically illustrates in a side view the insertion of another piercing device into an extraction unit according to the invention;

FIG. 4a schematically shows from above the piercing device of FIG. 4; and

FIG. 5 is a perspective view of a prior art piercing device.

### DETAILED DESCRIPTION OF THE INVENTION

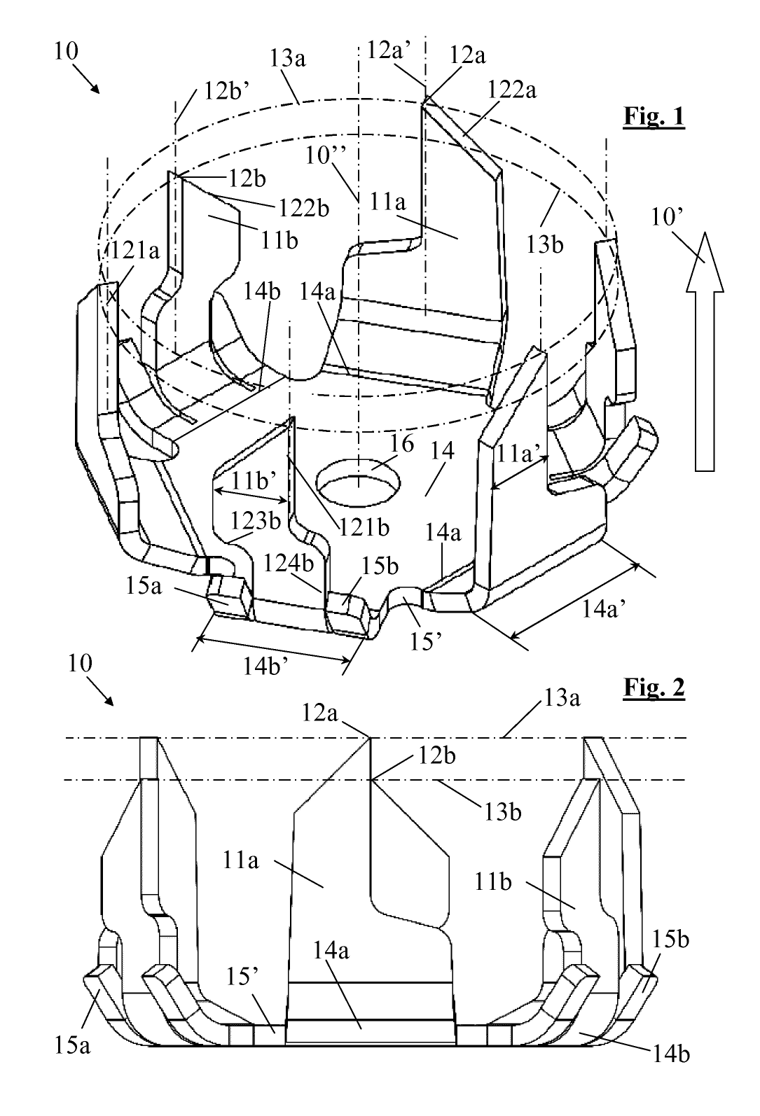

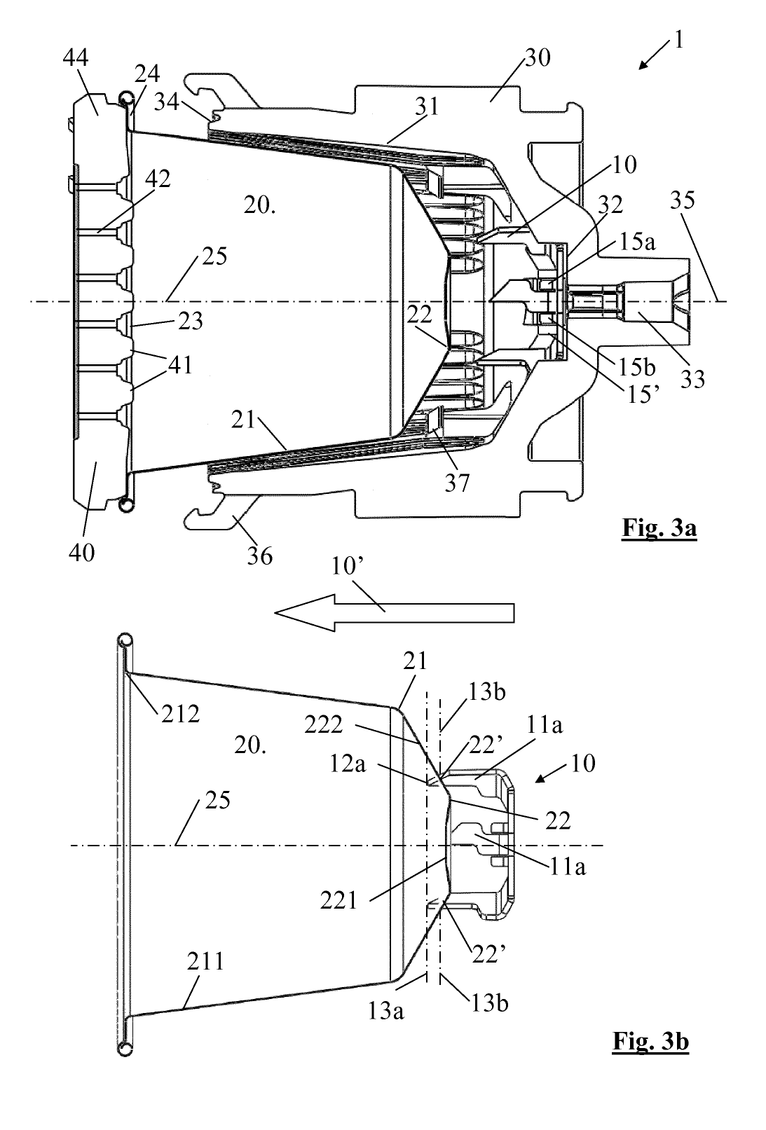

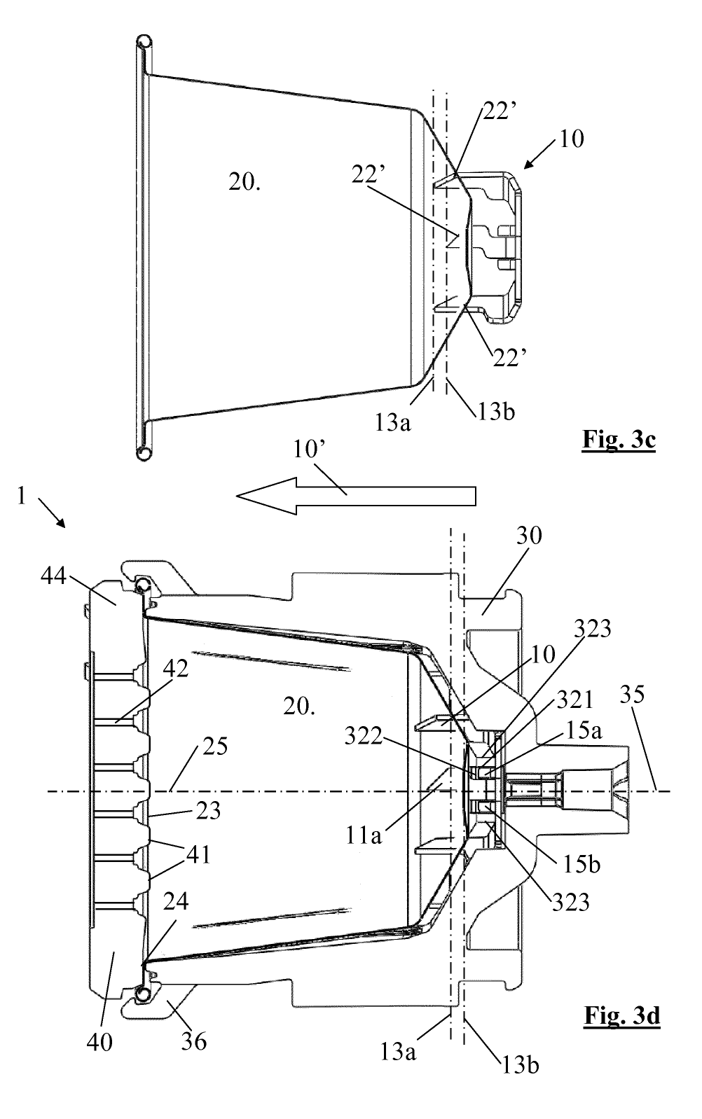

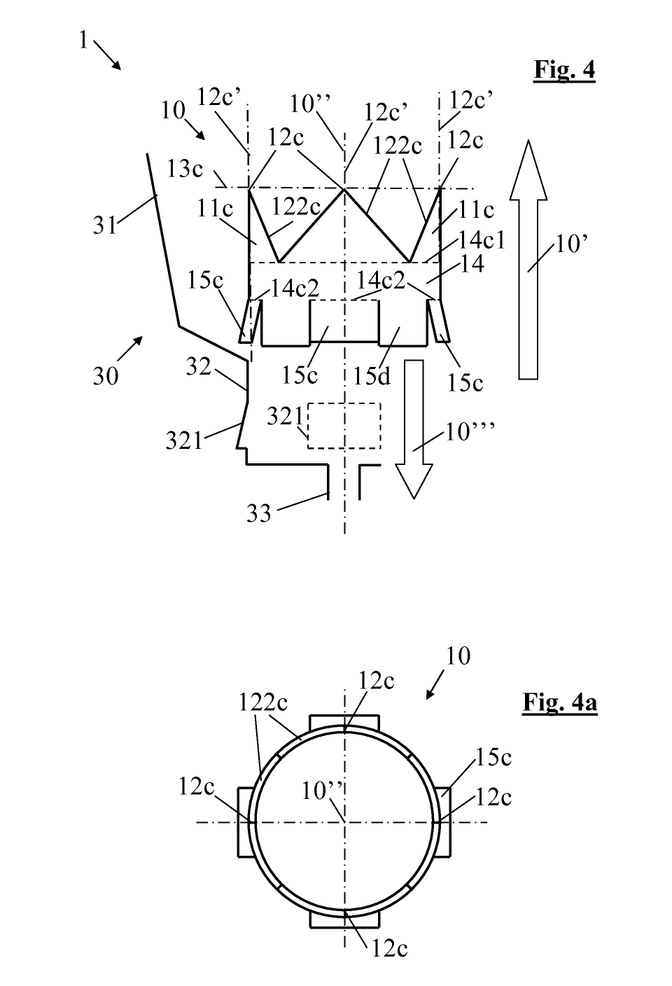

An example of an extraction unit 1 and its cooperation with a capsule 20 according to the invention is generally illustrated in FIGS. 1 to 3d. An extraction unit 1 having capsule receivers 30,40 and a piercing device 10 with a cooperating capsule 20 are shown in FIGS. 3a and 3d. Piercing device 10 is illustrated in detail in FIGS. 1 and 2. A piercing sequence of a capsule 20 is shown in FIGS. 3a to 3d. Another example according to the invention of a piercing device 10 in an extraction unit 1 is illustrated in FIGS. 4 and 4a.

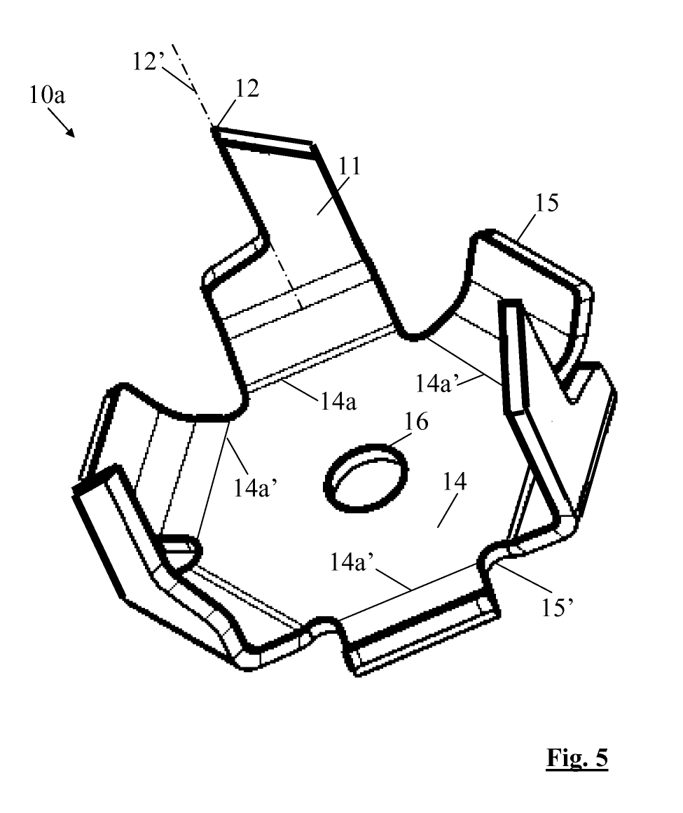

A comparative Example of a piercing device 10a which can be mounted in a receiver 30 and replaced by a piercing device 10 according to the invention is illustrated in FIG. 5.

Prior art piercing device 10a comprises three blades extending from a base 14 and spaced apart from one another by protruding fastening arrangements, such as protruding spring plates 15, for fastening piercing device 10a to capsule receiver 30 of the type shown in FIGS. 3a and 3d. Fastening arrangement 15 is movable, in particular slightly movable, relatively to blades 11 for the fastening with capsule receiver 30. For instance, piercing device 10a is mounted in receiver 30 by forcing protruding fastening arrangement 15 in corresponding shaped lateral anchorage cavities 321 in receiver 30, in particular in a recess 32 of receiver 30. Piercing device 10a may be associated with further fastening arrangements such as a through hole 16 for cooperating with a screw or rivet, in particular a hollow screw or rivet, that fixes piercing device 10a to receiver 30. Moreover, fastening arrangement may include recesses 15′ formed between protruding arrangement 15 and blade 11 that cooperates with a rib 323 of the extraction device 10, in particular a positioning and securing rib 323. Piercing device 10a can be made from a single bent plate, typically a metal plate, that is cut for forming blades 11 and fastening arrangements 15,15′,16.

Blades 11 have piercing edges 12. When piercing edges of blade 11 and a capsule 20 are urged together, piercing edges 12 pierce capsule 20 and blade 11 enters into capsule 20 to form an opening in capsule 20.

As illustrated in FIG. 3b, capsule 20 may have a container 21 with a bottom 22, for instance a bottom forming an injection or extraction face, and a cover 23, for instance a face forming an extraction face or injection face of capsule 20. Cover 23 extends laterally to form with a rim of container 21 a flange 24. Cover 23 can be appropriately joined to the rim of container 21 to form flange 24.

Typically, capsule 20 comprises a generally cylindrical or frusto-conical or domical or frusto-domical container 21 that has bottom 22 and cover 23. The entire or only part of the cover may be applied to the container; or the entire cover may be formed integrally with the container.

For instance, container 21 has an axis 25 of symmetry such as an axis 25 of revolution. Capsule 20 may have a face 22 to be pierced by all piercing extremities 12a,12b of piercing device 10, piercing face 22 being formed by the bottom or the cover of the capsule.

Container 21 can have a frusto-conical obtuse bottom and a fruto-conical acute body 211 extending from bottom 22 towards container mouth 212. Bottom 22 may have a generally flat or slightly convex or concave end 221 and a peripheral wall 222.

Container 21 may be made of plastic, biodegradable or aluminium material. cover 23 can be made of paper, plastic, biodegradable or aluminium material.

Capsule 20 typically contains an ingredient, e.g. a beverage ingredient such as coffee, tea, cocoa, milk, etc . . . . For instance, capsule 20 has a volume for containing 3 to 10 g ground coffee for the preparation of a ristretto, an espresso, a lungo or an americano coffee.

Suitable capsules are for example disclosed in EP 0 512 468, EP 0 512 470 and EP 2 068 684.

Capsule 20 may be extracted by circulating a liquid therethrough to mix it with an ingredient contained in capsule 20, e.g. a flavouring ingredient.

A first example of a piercing device 10 of an extraction unit 1 according to the invention, as shown in FIGS. 1 to 3d, will now be discussed in greater details when cooperating with capsule 20 and capsule receivers 30,40.

Piercing device 10 itself has: a base 14 with peripheral sections, such as generally straight peripheral sections 14a,14b; and a plurality of blades 11a,11b that protrude from base 14 along a longitudinal direction 12a′,12b′ (FIGS. 1 and 2). Longitudinal direction 12a′,12b′ is generally parallel to a direction 10′ of piercing capsule 20 in unit 1 (FIGS. 3a and 3d). Each blade 11a,11b extends laterally generally along one of peripheral sections 14a,14b (FIG. 1). Piercing device 10 further includes a plurality of assembly members 15a,15b. Each assembly member 15a,15b extends and protrudes from one of peripheral sections 14b.

Piercing device 10 may have a plurality of blades 11a,11b, each blade 11a,11b having a piercing extremity 12a,12b arranged to pierce capsule 20 in a piercing direction 10′, such as a direction 10′ generally parallel to a longitudinal axis 12a′12b′ of blades 11a,11b.

Piercing extremities 12a,12b are arranged to form at corresponding locations 22′ in capsule 20 either a series of corresponding inlet openings 22′ (FIGS. 3b and 3c) or a series of corresponding outlet openings (not shown).

Piercing extremities 12a,12b of blades 11a,11b may be arranged to pierce capsule 20 prior to circulating an extraction fluid into capsule 20.

At least one blade 11a,11b can have an edge 121a,121b that is generally parallel to piercing direction 10′ and an inclined edge 122a,122b intercepting the parallel edge to form piercing extremity 12a,12b.

In accordance with the invention, at least one assembly member 15a of the above assembly members 15a,15b is located at least in part generally in the longitudinal direction 12b′, under a corresponding blade 11b.

Assembly member(s) 15a can be located between the corresponding blade 11b and base 14. As illustrated, base 14 may be generally planar. Assembly member(s) 15a and the corresponding blade(s) 11b normally extend from the same peripheral section(s) 14b. Such corresponding blade 11b may form an overhang 123b under which, in longitudinal direction 12b′, at least part of assembly member 15a is located. Assembly member(s) 15a may extend from peripheral section(s) 14b in a direction generally parallel or at a small angle to longitudinal direction 12b′ of the corresponding blade(s) 11b.

Base 14, blades 11a,11b and assembly members 15a,15b are typically made of a single plate-like structure, in particular made from a single plate that is cut and bent to form base 14, blades 11a,11b and members 15a,15b.

Piercing device 10 can have: a first-type of blades 11b that is juxtaposed to at least one assembly member 15a,15b and that extends therewith from a first-type peripheral section 14b; and a second-type of blades 11a that extends alone from a second-type peripheral section 14a. Second-type peripheral section 14a can have a second width 14a′ generally equal to a first width 14b′ of first-type peripheral section 14b. First and second type blades 11a,11b may be positioned in alternation about an axis, such as a central axis 10″ and/or an axis 10″ parallel to piercing direction 10′, of piercing device 10.

By providing cut-outs for forming assembly members 15a,15b along lines 123b and 124b of blade 11b, the piercing width 11b′ formed by cutting edges 121b,122b of first-type blade(s) 11b can be maintained the same as the piercing width 11a′ formed by cutting edges 121a,122a of second-type blade(s) 11a. This is illustrated in FIG. 1.

Extraction unit 1 typically includes a first capsule receiver 30 in or on which piercing device 10 is mounted. For instance, receiver 30 is connected to a fluid line 33 for circulating a fluid into capsule 20 pierced by piercing device 10. For instance, piercing device 10 is mounted at a bottom 32 of receiver 30.

First capsule receiver 30 can have means for securing assembly members 15a,15b in receiver 30, such as recesses 321 and/or protrusions 322 cooperating with piercing device 10 (FIG. 3d). Securing means 321,322 of capsule receiver 30 may be further configured to secure assembly members 15 that extend over substantially an entire peripheral section 14a′ of base 14 and that are not located under any blade 11 in longitudinal direction 12′, as in the prior art piercing device 10a shown in FIG. 5. Hence, receiver 30 illustrated in FIGS. 3a and 3d may be a prior art receiver originally configured for receiving prior art piercing device 10a and into which piercing device 10 shown in FIGS. 1 to 3d can be fitted without having to change the configuration of receiver 30.

Assembly member(s) 15a,15b can be movable relative to piercing extremity 12b of the first-type blade(s) such as resiliently movable, in particular when formed of the same bent plate as piercing extremity 12b.

Hence, instead of alternating piercing blades and assembly members around a peripheral part of a base of a piercing device, piercing blades 11b and assembly members 15a,15b may be combined on the same peripheral edge 14b of base 14 so that the location at which assembly members 15a,15b extend from base 14 can also serve as a location from which piercing blade(s) 11b extend(s).

Passage 16 in piercing device 10 may be used to secure device 10 in receiver 30 and/or to allow a flow of liquid into or out of capsule 20 through piercer 10, in particular between capsule 20 and fluid line 33 of receiver 30. For example passage 16 is associated with a hollow screw or rivet member that fixes piercing device 10 in receiver 30, in particular at bottom 32, and allows the circulation of a fluid between capsule 20 and line 33.

Extraction unit 1 may include a second capsule receiver 40 that is movable relatively to first capsule receiver 30, between an open position for inserting or removing a capsule 20 from such unit 1 (not shown) and a closed position for extracting capsule 20 in such unit 1 (FIG. 3d).

The relative movement of first and second receivers 30,40 between the open and the closed positions, in particular from the open position to the closed position and vice versa, may be generally parallel to at least one of: piercing direction 10′, piercing device axis 10″ and blade axis 12a′,12b′. When piercing direction 10′ is parallel to the direction of the relative movement of first and second receivers 30,40 the closure of the receivers 30,40 may be used to pierce capsule 20 by piercing device 10.

Second receiver 40 may be arranged to hold capsule 20 against piercing extremities 12a,12b when first and second receivers 30,40 are relatively moved into the closed position generally parallel to piercing direction 10′, for instance as disclosed in WO 2005/004683 and EP 1859714.

In the exemplary embodiment illustrated in FIGS. 3a and 3d, first capsule receiver 30 has a cavity 31 for housing capsule 20, in particular capsule container 21 and second capsule receiver 40 forms a lid 44, in particular an outflow lid, for closing cavity 21. In particular, first receiver 30 has a mouth 34 through which capsule 20 can enter into cavity 21. In the closed position, capsule flange 24 may be squeezed between a peripheral part of lid 44 and mouth 34 (FIG. 3d) whereby cavity 31 can be sealed around capsule container 21 to avoid that liquid supplied via line 33 into cavity 31 bypasses capsule 20. Lid 44 includes a series of passages 42 for circulating liquid into or out of capsule 20 and a series of piercing or tearing protrusions 41 for opening capsule cover 23. As illustrated in the Figures, cavity 31 may have a central axis 35 that is generally identical with a central or symmetry axis 25 of capsule 20 when extraction unit 1 is in the extraction position.

First receiver 30 is fitted with retainers 36,37 for unsticking capsule 20 from second receiver 40, in particular for unsticking capsule cover 23 from flow collector 44, when first and second receivers 30,40 are relatively moved apart upon extraction. For instance, first retainer 36 retains capsule flange 24 and second retainer 37 retains capsule container 21. A third retainer (not shown) may be provided to remove capsule 30 from first and second retainers 36,37, e.g. a retainer that engages with capsule flange 24 when cover 23 is unstuck and that relatively moves capsule flange 24 away from mouth 34. Such a third retainer may be formed or associated with a guide channel that guides flange generally perpendicularly to axis 35 at introduction of capsule 20 into extraction unit 1 and/or at removal of capsule 20 from unit 1.

First and second capsule receivers 30,40 may be relatively moved by a manual action, e.g. as disclosed in WO 2005/004683, WO 2007/135135, WO2007/135136 or WO 2009/043630, or by an automatic action in particular a motorized action, e.g. as disclosed in EP 1767129, WO 2012/025258, WO 2012/025259, or a hydraulic or mixed action e.g. as in WO 2011/042400. These references also disclose suitable capsule handlings: to guide capsule 20 to an intermediate position between the spaced-apart receivers 30,40; move receivers 30,40 together into the extraction position with a capsule 20; and eject capsule 20 upon extraction when receivers 30,40 are spaced apart. In particular, piercing device 10 can be retrofitted into the extraction units disclosed in these references to form an extraction unit 1 according to the invention.

Extraction unit 1 may be mounted in a beverage preparation machine as known in the art, e.g. a machine provided with the functionalities disclosed in WO 2009/074550, such as a control unit, a user-interface, a fluid line, a pump, a temperature conditioner in particular a heater and/or a cooler, a water tank or other ingredient feeder, a waste ingredient collector, etc . . . .

To enhance the flow distribution inside capsule 20 it is desirable to multiply and distribute the passages or liquid into (or out from) capsules and therefore provide a plurality or blades.

In the absence of a sufficient resistance of the capsule, for instance in the absence of a sufficient internal pressure in the capsule or structural strength of the capsule, capsule 20 is particularly exposed to crushing by a piercing device that has a plurality of blades.

Piercing extremities 12a,12b may be generally located on different virtual piercing planes 13a,13b perpendicular to piercing direction 10′ (FIGS. 1 and 2).

Piercing extremities 12a,12b of at least one plane 13a,13b can be generally circularly arranged and optionally evenly spaced apart (FIG. 1).

Each piercing extremity 12a,12b may have a piercing axis 12a′,12b′ parallel to piercing direction 10′. In such a case, blades 11a,11b of piercing device 1 can be in a generally cylindrical arrangement about a generally central axis 10″ of piercing device 10 and being optionally evenly spaced apart.

Piercing extremities 12a,12b can be spatially arranged relatively to the piercing locations 22′ to contact and penetrate capsule 20 at piercing locations 22′ at different respective moments in time (FIGS. 3a and 3b).

By providing such an arrangement, piercing device 10 can be fitted with a large number of blades forming a corresponding number of inlet or outlet openings for distributing the flow of liquid at the openings with a reduced risk of crushing the capsule when the openings are formed at different moments in time.

Piercing locations 22′ can be located on a capsule portion 22 that is non-parallel to piercing planes 13a,13b, in particular the capsule portion is a non-planar face 22, such as a generally conical, domical, polyhedral or mixed face 221,222.

For example, capsule has a face 22 to be pierced by all piercing extremities 12a,12b of piercing device 10, capsule face 22 being optionally so deformable as to deform without piercing over at least 5% of an overall size of the capsule in piercing direction 10′, in particular deform without piercing over at least 10% or 15% thereof, if capsule face 22 were in contact with and urged against all the piercing extremities of the piercing device to be pierced at the same moment in time, capsule face 22 being for instance made of at least one of metal such as aluminium, plastic, and biodegradable material.

Each piercing plane 13a,13b may have a total number of piercing extremities 12a,12b of 1, 2, 3, 4, 5, 6, 7 or 8. In the particular example illustrated in FIGS. 1 to 3d, each piercing plane 13a,13b has three piercing extremities 12a,12b.

Piercing device 10 shown in FIGS. 1 to 3d is made of a single bent plate that is cut to form base 14 and blades 11a,11b. Assembly arrangements 15a,15b,15′,16 may also be formed in the bent plate to assemble piercing device 10 in such unit 1, e.g. to a capsule receiver 30 of unit 1. Piercing device 10 may be made of a bent metal plate.

For instance, blades 11a,11b and assembly member(s) 15a,15b are bent at an angle in the range of 75 to 105 deg, such as 85 to 95 deg, relative to base 14.

During operation, capsule 20 and piercing device 10 are positioned to face each other, then capsule 20 and piercing device 10 are urged against each other along piercing direction 10′. Two different piercing extremities 12a,12b of device 10 may contact and penetrate capsule 20 at different respective moments.

FIGS. 3a to 3d illustrate in greater details an example of such a process in which capsule 20 is located inbetween capsule receivers 30,40 with piercing device 10: in FIG. 3a capsule 20 is held in front of piercing device 10 at a distance thereof; in FIG. 3b, piercing device 10 and capsule 20 are urged against each other so that piercing extremities 12a of plane 13b pierce and enter capsule 20 whereas piercing extremites 12b of plane 13b are still located outside capsule 20; the entry into capsule 20 of piercing extremities 12b of plane 13b is shown in FIG. 3c; full entry of extraction device 10 is shown in FIG. 3d in which extraction unit 1 is in the extraction position.

Capsule 20 can be used in extraction unit 1 for forming a beverage of any type, in particular coffee, tea, chocolate, milk and soup.

FIGS. 4 and 4a, in which the same numeric references designate generally the same elements, illustrate another piercing device 10 for an extraction unit 1 according to the invention.

Piercing device 10 has a base 14 with peripheral sections, such as generally straight peripheral sections 14c1,14c2. In this context “generally straight” includes a slight curve 14c2 resulting from bending a tubular section 15c away from the tubular axis 10″. Device 10 further includes a plurality of blades 11c that protrude from base along a longitudinal direction 12c′, in particular a longitudinal direction that is generally parallel to a direction 10′ of piercing capsule 20 in such unit. Each blade 11c extends laterally generally along one of peripheral sections 14c1. Moreover, device 10 has a plurality of assembly members 15c. Each member 15c can extend and protrude from one of peripheral sections 14c2.

In accordance with the invention, at least one assembly member 15c is located at least in part generally in the longitudinal direction 12c′ under a corresponding blade 11c. As illustrated in FIG. 4, the foot of assembly member 15c can extend from peripheral section 14c2 generally from the axis 12c′ and slightly angled thereto.

Base 14 may extend between at least one assembly member 15c and the corresponding blade 11c. Base 14 can be generally annular. At least one assembly member 15c can extend from an assembly peripheral section 14c2 of base 14 that is opposite a blade peripheral section 14c1. Such peripheral sections 14c1,14c2 of base 14 can be generally parallel to one another.

Each blade 11c can have a piercing extremity 12c arranged to pierce capsule 20 in a piercing direction 10′, such as a direction 10′ generally parallel to longitudinal direction 12c′ of blade 11c at piercing extremity 12c.

Piercing extremities 12c may be arranged to form at corresponding locations 22′ in capsule 20 either a series of corresponding inlet openings or a series of corresponding outlet openings. Piercing extremities 13c may be all arranged on a single plane 13c, in particular a plane perpendicular to piercing direction 10′ or to longitudinal blade direction 12c′. Piercing extremities 12c of blades 11c can be arranged to pierce capsule 20 prior to circulating an extraction fluid into capsule 20.

Piercing extremities 12c can be generally arranged in a circle or in an oval arrangement on a plane 13c and optionally evenly spaced apart. Each piercing extremity 12c can have a piercing axis 12c′ parallel to piercing direction 10′. Blades 11c of the piercing device 10 may be in a generally cylindrical arrangement about a generally central axis 10′ of piercing device 10 and being optionally evenly spaced apart. Piercing plane 13c may have a total number of piercing extremities 11c of 1, 2, 3, 4, 5, 6, 7 or 8. In FIGS. 4 and 4a, device 10 has a total number of 4 piercing extremities 12c.

At least one blade 11c can have two edges 122c inclined to piercing direction 10′ and intercepting each other to form piercing extremity 12c.

Piercing device 10 can be fitted into a bottom 32 of a capsule receiver 30 (schematically shown in part in FIG. 4) and assembly members 15c may be housed in cavities 321 in recess 32. Piercing device 10 may be mounted into receiver 30 along direction 10′″. A corresponding tool, e.g. tubular tool, may be needed to urge assembly members 15c towards central axis 10″ so as to be able to entre recess 32. Assembly members 15c may be resilient to expand in cavities 321 once piercing device 10 is in place in recess 32.

Piercing device 10 may further include sections 15d inbetween assembly members 15c. Sections 15d may contribute to the stabilization and positioning of device 10 in capsule receiver 30.

1. A capsule extraction unit having a piercing device 404 for piercing a capsule, the piercing device comprising:
a base with peripheral sections;
a plurality of blades that protrude from the base along a longitudinal direction;
a plurality of assembly members, each assembly member extending and protruding from one of the peripheral sections; and
at least one assembly member of said the assembly members is located at least in part generally in the longitudinal direction under a corresponding blade.

2. The unit of claim 1, wherein at least one assembly member is located between the corresponding blade and the base.

3. The unit of claim 2, wherein at least one assembly member and the corresponding blade extend from the same peripheral section.

4. The unit of claim 1, wherein the corresponding blade forms an overhang under which in the longitudinal direction at least part of the assembly member is located.

5. The unit of claim 1, wherein the base extends between at least one assembly member and the corresponding blade.

6. The unit of claim 5, wherein at least one assembly member extends from an assembly peripheral section of the base that is opposite a blade peripheral section.

7. The unit of claim 1, wherein at least one assembly member extends from the peripheral section in a direction generally parallel to the longitudinal direction of the corresponding blade.

8. The unit of claim 1, wherein the base, the blades and the assembly members are made of a single plate-like structure.

9. The unit of claim 1, wherein each blade has a piercing extremity arranged to pierce the capsule in a piercing direction, the piercing extremities being arranged to form at corresponding locations in the capsule either a series of corresponding inlet openings or a series of corresponding outlet openings, the piercing extremities of the blades being in particular arranged to pierce said capsule prior to circulating an extraction fluid into the capsule.

10. The unit of claim 9, wherein the piercing extremities are generally located on different virtual piercing planes that are generally perpendicular to the piercing direction.

11. The unit of claim 1, wherein the piercing device has: a first-type of blades that is juxtaposed to at least one assembly member and that extends therewith from a first-type peripheral section; and a second-type of blades that extends alone from a second-type peripheral section.

12. The unit of claim 1, wherein at least one blade has:
an edge that is generally parallel to the piercing direction and an inclined edge intercepting the parallel edge to form the piercing extremity; or
two edges inclined to the piercing direction and intercepting each other to form the piercing extremity.

13. The unit of claim 1, which comprises a first capsule receiver having a member for securing assembly members in a receiver, such as recesses and/or protrusions cooperating with a piercing device, that extend over substantially an entire peripheral section of the base and that are not located under any blade in the longitudinal direction.

14. The unit of claim 13, comprising a second capsule receiver that is movable relatively to the first capsule receiver, between an open position for inserting or removing a capsule from such extraction unit and a closed position for extracting the capsule in such unit.

15. A combination of an extraction unit and capsule, the extraction unit having a piercing device for piercing the capsule, the piercing device comprising:
a base with peripheral sections;
a plurality of blades that protrude from the base along a longitudinal direction;
a plurality of assembly members, each assembly member extending and protruding from one of the peripheral sections; and
at least one assembly member of the assembly members is located at least in part generally in the longitudinal direction under a corresponding blade.

16. A method of piercing a capsule comprising urging the capsule relatively against a piercing device for piercing a capsule, the piercing device comprising: a base with peripheral sections; a plurality of blades that protrude from the base along a longitudinal direction; a plurality of assembly members, each assembly member extending and protruding from one of the peripheral sections; and at least one assembly member of the assembly members is located at least in part generally in the longitudinal direction under a corresponding blade along the piercing direction.

17. (canceled)

18. The unit of claim 1, wherein each blade has a piercing extremity arranged to pierce the capsule in a piercing direction, and a plurality of the piercing extremities being generally arranged in a circle or in an oval arrangement on a plane; and
each piercing extremity having a piercing axis parallel to the piercing direction, the blades of the piercing device being in a generally cylindrical arrangement about a generally central axis of the piercing device.

19. The unit of claim 1, wherein the piercing device has: a first-type of blades that is juxtaposed to at least one assembly member and that extends therewith from a first-type peripheral section; and a second-type of blades that extends alone from a second-type peripheral section (14a),
the second-type peripheral section having a second width generally equal to a first width of the first-type peripheral section, and
the first and second type blades being positioned in alternation about an axis of the piercing device.
